(19) United States
(12) Patent Application Publication
(10) Pub. No.: US 2025/0142265 A1
(43) Pub. Date: May 1, 2025

(54) Sound Output Device

(71) Applicant: Sony Group Corporation, Tokyo (JP)

(72) Inventor: Masahiro Takahashi, Saitama (JP)

(73) Assignee: Sony Group Corporation, Tokyo (JP)

(21) Appl. No.: 18/837,258

(22) PCT Filed: Feb. 3, 2023
(86) PCT No.: PCT/JP2023/003511

§ 371 Date: Aug. 9, 2024

(30) Foreign Application Priority Data
Feb. 16, 2022 (JP) 2022-022010

(51) Int. Cl. H04R 17/00; G06F 1/16; H04R 1/02

(52) U.S. Cl. CPC H04R 17/00; G06F 1/1605; H04R 1/025; H04R 2499/15

(57) ABSTRACT

A sound output device includes a member to be vibrated that outputs sound to a space, a vibration mechanism that vibrates the member to be vibrated, and a transmission member that transmits vibration of the vibration mechanism to the member to be vibrated, in which the vibration mechanism includes an actuator that generates the vibration along a predetermined vibration axis, and an abutment member that is provided near the transmission member in an axial direction of the vibration axis of the actuator to transmit the vibration generated by the actuator to the transmission member, and the transmission member includes a first end portion that makes contact with the abutment member, and a second end portion that makes contact with the member to be vibrated.

### FIELD

The present disclosure relates to a sound output device.

### BACKGROUND

In a thin display panel, it is known that a frame member of the display panel is vibrated by an actuator to output sound.

### CITATION LIST

### Patent Literature

Patent Literature 1: JP 4655243 B2
Patent Literature 2: JP 6237768 B2

### SUMMARY

### Technical Problem

However, when the actuator is arranged so as to make contact with the frame member of the display panel, it is difficult to reduce the thickness of the display panel in the vicinity of an outer periphery thereof.

The present disclosure proposes a sound output device that is configured to stably transmit a force of an actuator to a member to be vibrated, while reducing the thickness of an image display device.

### Solution to Problem

According to the present disclosure, a sound output device includes: a member to be vibrated that outputs sound to a space; a vibration mechanism that vibrates the member to be vibrated; and a transmission member that transmits vibration of the vibration mechanism to the member to be vibrated, wherein the vibration mechanism includes: an actuator that generates the vibration along a predetermined vibration axis; and an abutment member that is provided near the transmission member in an axial direction of the vibration axis of the actuator to transmit the vibration generated by the actuator to the transmission member, and the transmission member includes: a first end portion that makes contact with the abutment member; and a second end portion that makes contact with the member to be vibrated.

### BRIEF DESCRIPTION OF DRAWINGS

FIG. 1 is a diagram illustrating an exemplary configuration of an image display device according to an embodiment of the present disclosure.

FIG. 2A is a diagram illustrating an exemplary configuration of a vibration mechanism.

FIG. 2B is a diagram illustrating an exemplary configuration of the vibration mechanism.

FIG. 3 is a diagram illustrating an exemplary configuration of an actuator.

FIG. 4A is a diagram illustrating an exemplary configuration of a support member.

FIG. 4B is a diagram illustrating an exemplary configuration of the support member.

FIG. 4C is a diagram illustrating an exemplary configuration of the support member.

FIG. 5 is a perspective view illustrating an exemplary configuration of a sound output device according to an embodiment of the present disclosure.

FIG. 6 is a cross-sectional view illustrating an exemplary configuration of a portion in the vicinity of the sound output device taken along line D-D of FIG. 1.

FIG. 7 is a cross-sectional view of the vibration mechanism and a transmission member.

FIG. 8 is a top view of the transmission member according to an embodiment of the present disclosure.

FIG. 9 is an enlarged view illustrating an example of a first end portion of the transmission member.

FIG. 10 is an enlarged cross-sectional view of contact portions of an abutment member of the vibration mechanism and a first end portion of the transmission member.

FIG. 11 is an enlarged view illustrating an example of a cushion member provided between a cover member of the vibration mechanism and the transmission member.

FIG. 12 is a perspective view illustrating an exemplary configuration of a sound output device according to a first modification.

FIG. 13 is a cross-sectional view illustrating an exemplary configuration of a portion in the vicinity of the sound output device according to the first modification.

FIG. 14 is a perspective view illustrating an exemplary configuration of a sound output device according to a second modification.

FIG. 15 is a cross-sectional view illustrating an exemplary configuration of a portion in the vicinity of the sound output device according to the second modification.

FIG. 16 is a diagram illustrating an exemplary configuration of a sound output device according to a third modification.

FIG. 17 is a diagram illustrating an exemplary configuration of a sound output device according to a fourth modification.

### DESCRIPTION OF EMBODIMENTS

Embodiments of the present disclosure will be described in detail below with reference to the drawings. Note that in the following embodiments, the same portions are denoted by the same reference numerals or symbols, and repetitive description thereof will be omitted.

Furthermore, the present disclosure will be described in the order of items shown below.
1. Embodiment
1-1. Configuration of image display device according to embodiment
1-2. Configuration of vibration mechanism of sound output device according to embodiment
1-3. Configuration of sound output device according to embodiment
2. Modifications of embodiment
3. Effects

### 1. Embodiment

### [1-1. Configuration of Image Display Device According to Embodiment]

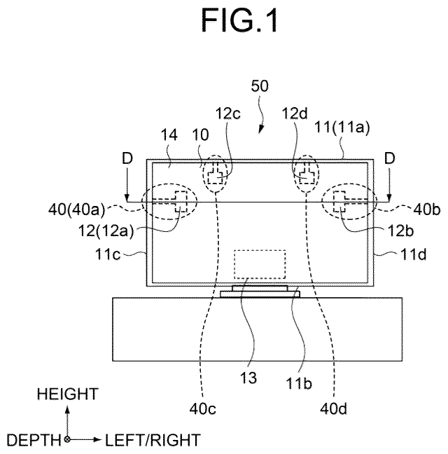

FIG. 1 is a diagram illustrating an exemplary configuration of an image display device according to an embodiment of the present disclosure. An image display device 50 illustrated in FIG. 1 is, for example, a television device that displays a video based on television broadcasting. The image display device 50 is placed on a horizontal surface such as a floor, a shelf, or a table. Here, as illustrated in FIG. 1, a left/right direction, an up/down direction, and a depth direction are defined when the image display device 50 is viewed from the front. Note that a method of installing the image display device 50, the orientation, direction, or the like in use thereof are not limited thereto.

The image display device 50 includes a display panel 10, a frame 11, a vibration mechanism 12, and a control unit 13. Furthermore, a sound output device 40 includes part of the frame 11, the vibration mechanism 12, and a transmission member 15 which is described later. The display panel 10 is a display device that displays an image on a display surface 14. For the display panel 10, for example, any type of display panel such as a liquid crystal panel or an organic electro luminescence (EL) panel can be used. The display panel 10 displays the image input from the control unit 13.

The frame 11 supports the periphery of the display panel 10. The frame 11 includes a frame 11a that supports an upper edge of the display panel 10, a frame 11b that supports a lower edge, a frame 11c that supports a left edge, and a frame 11d that supports a right edge, when the display panel 10 is viewed from the front. Note that the frames 11a to 11d may be constituted individually or may be integrally constituted as the frame 11 of frame shape. The frame 11 includes, for example, a metal material such as aluminum. Note that the frame 11 may include another material such as a resin. Furthermore, in the following description, the frames 11a to 11d will be referred to as the frame 11 when not distinguished from each other.

For example, as illustrated in FIG. 1, the vibration mechanism 12 includes vibration mechanisms 12a and 12b that are provided on the left and right sides of the display panel 10, respectively, and vibration mechanisms 12c and 12d that are provided at the upper part of the display panel 10. The vibration mechanisms 12a to 12d correspond to sound output devices 40a to 40d, respectively. Note that in the following description, the vibration mechanisms 12a to 12d will be referred to as the vibration mechanism 12 when not distinguished from each other. In addition, when the sound output devices 40a to 40d will be referred to as a sound output device 40 when not distinguished from each other. The vibration mechanism 12 is arranged inside the image display device 50 and vibrates the frame 11 as the member to be vibrated, via the transmission member 15 which is described later. In the example of FIG. 1, the vibration mechanism 12a vibrates the frame 11c on the left side, the vibration mechanism 12b vibrates the frame 11d on the right side, and the vibration mechanisms 12c and 12d vibrate the frame 11a on the upper side. The vibration mechanism 12 vibrates the frame 11 as the member to be vibrated, via the transmission member 15 to output sound to a space.

The vibration mechanisms 12a and 12b are arranged at equal positions (equal height) in the up/down direction. In other words, portions of the frame 11c on the left side and the frame 11d on the right side that have the same height are vibrated by the vibration mechanisms 12a and 12b via the transmission members 15. The vibration mechanisms 12c, 12d are arranged at positions equal from the center of the display panel 10 in the left/right direction. In other words, the frame 11a on the upper side is vibrated at the positions equal from the center of the display panel 10 by the vibration mechanisms 12c and 12d via the transmission members 15. Note that a position where the vibration mechanism 12 is arranged, that is, the position of a point vibrated by the vibration mechanism 12 is not limited. For example, the vibration mechanisms 12a and 12b on the left and right sides may be arrange at different heights.

Here, direct vibration of the frame 11 by the vibration mechanism 12 will be considered. In this case, the vibration mechanism 12 is arranged so as to make contact with the frame 11, and therefore, the vibration mechanism 12 is required to have a thickness allowed to be arranged in the vicinity of the frame 11. In other words, it is difficult to reduce the thickness of the display panel 10 near the outer periphery thereof.

The image display device 50 according to the present disclosure has a configuration as described below to stably transmit a force of an actuator of the vibration mechanism 12 to the frame 11 as the member to be vibrated, while reducing the thickness of the image display device 50. Specifically, the sound output device 40 in the image display device 50 includes the frame 11 that outputs sound to a space, the vibration mechanism 12 that vibrates the frame 11, and the transmission member 15 that transmits the vibration of the vibration mechanism 12 to the frame 11. The vibration mechanism 12 includes the actuator that generates vibration along a predetermined vibration axis, and an abutment member that is provided near the transmission member 15 in an axial direction of the vibration axis of the actuator to transmit vibration generated by the actuator to the transmission member 15. The transmission member 15 includes a first end portion that makes contact with the abutment member and a second end portion that makes contact with the frame 11.

The control unit 13 integrally controls the operation of the image display device 50. The control unit 13 is implemented, for example, by executing programs stored in an internal storage device by using a central processing unit (CPU) or a micro processing unit (MPU), with a random access memory (RAM) as a working area. In addition, the control unit 13 may be implemented by an integrated circuit such as an application specific integrated circuit (ASIC) or a field programmable gate array (FPGA).

In the control unit 13, a CPU or the like executes a predetermined program to configure a vibration control unit as a functional block. The vibration control unit controls vibration operations of the vibration mechanisms 12a to 12d on the basis of voice information. This configuration makes it possible to directly output voice from the frame 11c on the left side, the frame 11d on the right side, and the frame 11a on the upper side of the image display device 50. In other words, the frame 11c on the left side, the frame 11d on the right side, and the frame 11a on the upper side are configured to function as speakers.

### [1-2. Configuration of Vibration Mechanism of Sound Output Device According to Embodiment]

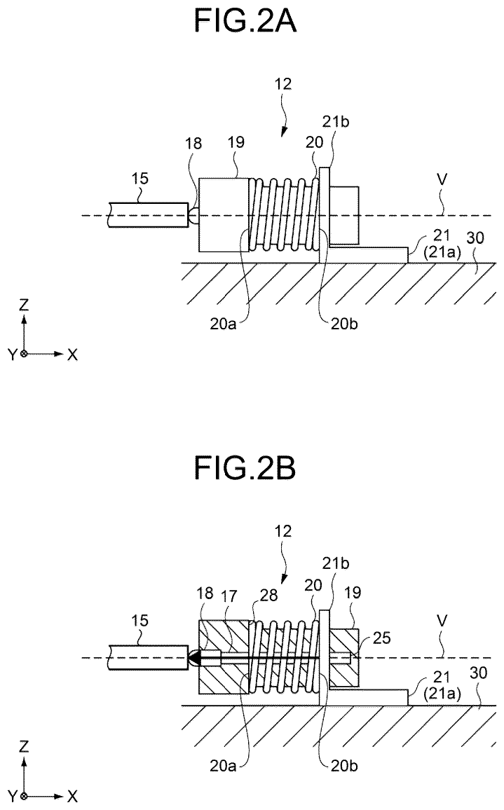

First, the configuration of the vibration mechanism 12 in the sound output device 40 will be described. FIGS. 2A and 2B are diagrams each illustrating an exemplary configuration of the vibration mechanism. As illustrated in FIGS. 2A and 2B, the vibration mechanism 12 generates vibration along the vibration axis V and vibrates the frame 11 via the transmission member 15. The vibration axis V is an example of the predetermined vibration axis. Here, a side of the vibration mechanism 12 facing the transmission member 15 is defined as a front side of the vibration mechanism 12. Furthermore, as illustrated in FIGS. 2A and 2B, the directions of the vibration mechanism 12 are defined as follows. A front-back direction (X direction) of the vibration mechanism 12 is defined as the axial direction of the vibration axis V. A left/right direction (Y direction) of the vibration mechanism 12 is defined as a direction orthogonal to the axial direction of the vibration axis V and corresponding to the left/right side when the front side of the vibration mechanism 12 is viewed in the axial direction of the vibration axis V. An up/down direction (Z direction) of the vibration mechanism 12 is defined as a direction orthogonal to the axial direction of the vibration axis V and corresponding to the upper/lower side when the front side of the vibration mechanism 12 is viewed in the axial direction of the vibration axis V. Note that the X, Y, and Z directions illustrated in FIGS. 2A and 2B can be set appropriately regardless of the up/down, left/right, and depth directions of the image display device 50 illustrated in FIG. 1. In other words, the vibration mechanism 12 can be installed in an appropriate direction (orientation) on the inside of the image display device 50. Therefore, the direction of the vibration axis V (vibration direction) is not limited and can be appropriately set.

FIG. 2A is a side view of the vibration mechanism 12 as viewed from the right side. FIG. 2B is a cross-sectional view of only a support member 19 of the vibration mechanism 12 illustrated in FIG. 2A, taken in the up/down direction through the vibration axis V. The vibration mechanism 12 includes an actuator 17, an abutment member 18, the support member 19, an urging member 20, and a fixing member 21.

The actuator 17 generates vibration along the vibration axis V. For the actuator 17, for example, a piezoelectric element (piezo element), a dielectric elastomer, or the like can be used that is capable of electromechanical conversion. For example, a piezoelectric actuator such as a lead zirconate titanate (PZT) stack has characteristics of small size, high reliability, stable material characteristics, high stress, high bandwidth, and high power density.

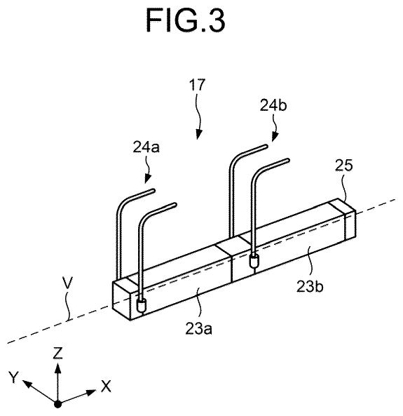

Here, the actuator 17 will be described with reference to FIG. 3, and FIG. 3 is a diagram illustrating an exemplary configuration of the actuator. As illustrated in FIG. 3, for example, in the actuator 17, piezoelectric elements 23a and 23b that extend in one direction are connected and arranged along the vibration axis V. The piezoelectric elements 23a and 23b include lead wires 24a and 24b to which voltage is applied via wiring which is not illustrated. This configuration makes it possible to generate displacement of each of the piezoelectric elements 23a and 23b, as vibration along the vibration axis V. The piezoelectric elements 23a and 23b may be individually driven or may be driven in common. In addition, a wiring structure electrically connected to the lead wires 24a and 24b is not limited, and may be appropriately designed.

Using the connected two piezoelectric elements 23a and 23b, vibration can be stably generated, and a high acoustic characteristic can be provided. For example, an amplitude of approximately 1.5 μm to 2.0 μm can show sufficient acoustic characteristic. Note that the amplitude of the vibration generated by the actuator 17 is not limited, and may be appropriately designed so as to have a desired acoustic characteristic. Furthermore, the configuration of the actuator 17 is not limited, and any configuration may be adopted. As illustrated in FIGS. 2B and 3, an end portion of the actuator 17 on a side opposite from the transmission member 15 in the axial direction (X direction) of the vibration axis V is defined as a rear side end portion 25. A flat surface at the rear side end portion 25 is an example of a second flat surface of the actuator 17.

Description will be made with reference to FIGS. 2A and 2B again. The abutment member 18 is connected to the actuator 17 and configured to abut on the transmission member 15. In other words, the vibration generated by the actuator 17 is transmitted to the transmission member 15 via the abutment member 18. For the abutment member 18, for example, a member made of brass is used that has a large specific gravity and good sound. This configuration makes it possible to improve the acoustic characteristic. Note that the shape, material, forming method, or the like of the abutment member 18 is not limited, and may be appropriately designed.

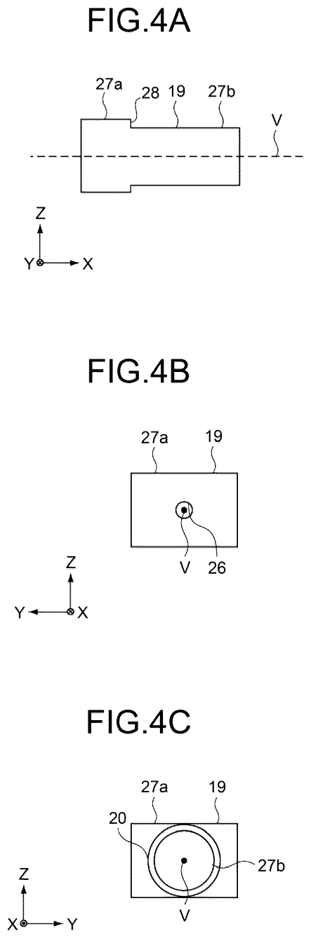

Next, the support member 19 will be described with reference to FIGS. 4A to 4C. FIGS. 4A to 4C are diagrams illustrating an exemplary configuration of the support member. FIG. 4A is a side view of the support member 19 as viewed from the right side. FIG. 4B is a front view of the support member 19 as viewed from the front side. FIG. 4C is a diagram of the support member 19 with the urging member 20 mounted as viewed from the rear side.

The support member 19 supports the actuator 17. As illustrated in FIG. 4B, a support hole 26 is formed in the support member 19 along the vibration axis V. The support member 19 is formed into a hollow shape to internally store and support the actuator 17. Furthermore, the support member 19 is configured to connect a front side portion 27a and a rear side portion 27b in the axial direction of the vibration axis V. The front side portion 27a has a rectangular parallelepiped shape, and the rear side portion 27b has a cylindrical shape. A step is formed at a connected portion between the front side portion 27a and the rear side portion 27b, and functions as a front side support portion 28 that supports a front side end portion 20a of the urging member 20.

For the support member 19, a die-cast member is used that is formed by a die casting method (die casting). For example, the support member 19 can be formed using an aluminum alloy, a zinc alloy, a magnesium alloy, or the like. Use of the die casting method makes it possible to suppress transmission loss of vibration, stably vibrating the transmission member 15. Therefore, the acoustic characteristic can be improved. Furthermore, for the support member 19, a pressed member may be used that is formed by a press method (press working). For example, the support member 19 can be formed using brass or the like. Furthermore, the support member 19 can be configured by assembling a plurality of members. For example, the support member 19 may be configured by assembling a material made of a resin material such as polycarbonate (PC) and the pressed member. This configuration makes it possible to suppress the component cost. The shape, material, forming method, or the like of the support member 19 is not limited, and may be appropriately designed.

Description will be made with reference to FIGS. 2A and 2B again. The fixing member 21 fixes the support member 19 to a predetermined position of the image display device 50. For example, as illustrated in FIGS. 2A and 2B, the fixing member 21 is connected to a predetermined stationary member 30 included in the image display device 50. The support member 19 is held by the fixing member 21 and fixed to the stationary member 30. The fixing member 21 includes, for example, a metal material such as aluminum, electrogalvanized steel (SECC), or a cold rolled material (e.g., SPCC). The shape, material, forming method, or the like of the fixing member 21 is not limited, and may be appropriately designed.

The fixing member 21 includes a connecting portion 21a and a holding portion 21b. The connecting portion 21a having a flat plate shape and the holding portion 21b having a flat plate shape are orthogonally connected to each other. Therefore, the fixing member 21 has an L shape as a whole. The connecting portion 21a is connected to the stationary member 30. Note that a configuration and method for connecting the connecting portion 21a to the stationary member 30 are not limited, and any method such as screwing or welding can be used.

The holding portion 21b holds the support member 19. A mounting hole is formed in the holding portion 21b in the axial direction (X direction) of the vibration axis V. The rear side portion 27b of the support member 19 is inserted into the mounting hole and held therein. Note that a configuration and method for connecting the support member 19 to the holding portion 21b are not limited, and any method can be used.

The urging member 20 urges the support member 19 toward the transmission member 15. In other words, the urging member 20 applies a force toward the transmission member 15 to the support member 19. As illustrated in FIGS. 2A, 2B, and 4C, the urging member 20 is provided around the support member 19 when viewed along the vibration axis V. In other words, when viewed from the front side or the rear side along the vibration axis V, the urging member 20 is arranged at a portion being a side surface of the support member 19. The urging member 20 is arranged to cover the entire periphery (side surface) of the support member 19, but is not limited to this configuration. The urging member 20 may be arranged at a part of the periphery of the support member 19. As the urging member 20, for example, a coil spring is arranged around the support member 19. In the following description, the urging member 20 is also referred to as a coil spring 20. The coil spring 20 is mounted to the rear side portion 27b of the support member 19.

The front side end portion 20a of the coil spring 20 is supported by the front side support portion 28 that is the step formed on the support member 19, in the axial direction of the vibration axis V. The coil spring 20 has a rear side end portion 20b that is supported by the holding portion 21b of the fixing member 21. In other words, the holding portion 21b functions as a rear side support portion that holds the rear side end portion 20b. Therefore, the actuator 17 and the abutment member 18 that are supported by the support member 19 are also urged toward the transmission member 15. Therefore, the vibration generated by the actuator 17 is allowed to be stably transmitted to the transmission member 15. In other words, sound pressure can be stabilized. Note that the specific magnitude of an urging force (load) generated by the urging member 20 is not limited. For example, the urging force is set to such a magnitude that the transmission member 15 is not unexpectedly deformed. In addition, the urging force is set to a magnitude capable of accommodating deformation due to assembly tolerance, aged deterioration, or the like. For example, applying a load of 2.0 kgf to 3.0 kgf as the urging force, it is possible to accommodate a deviation of approximately +3.0 mm in the axial direction of the vibration axis V, that is, a relative positional displacement between a point of vibration of the transmission member 15 and the vibration mechanism 12. Therefore, the acoustic characteristic can be sufficiently provided. Note that the urging force is not limited to the range described above.

As illustrated in FIG. 2B, the coil spring 20 is arranged closer to the transmission member 15 relative to the rear side end portion 25 of the actuator 17. In other words, the rear side end portion 20b of the coil spring 20 is arranged on the front side from the rear side end portion 25 of the actuator 17. In other words, the coil spring 20 is arranged around the actuator 17 and overlaps the actuator 17 in the axial direction of the vibration axis V. This configuration makes it possible to reduce the size of the vibration mechanism 12 in the front-back direction (depth direction). Note that a specific configuration of the coil spring 20, for example, a free length, a spring constant, or the like is not limited. Furthermore, a leaf spring may be used for the urging member 20.

### [1-3. Configuration of Sound Output Device According to Embodiment]

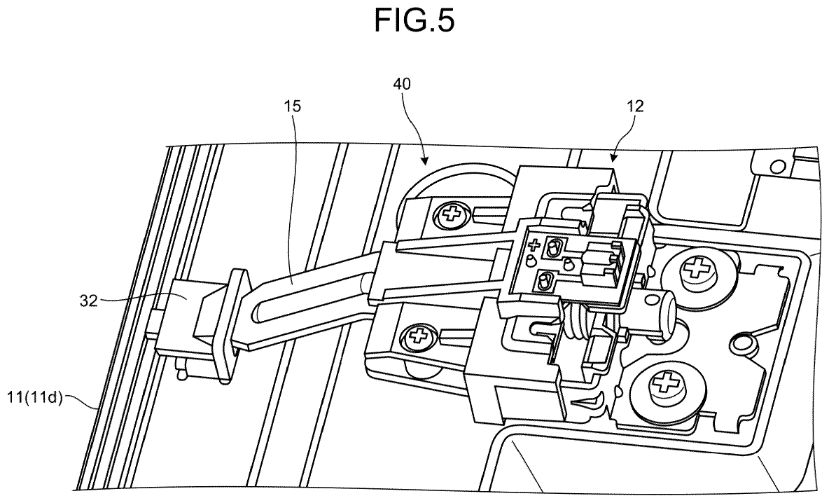

Next, the configuration of the sound output device 40 according to an embodiment will be described. FIG. 5 is a perspective view illustrating an exemplary configuration of the sound output device according to the embodiment of the present disclosure. As illustrated in FIG. 5, the sound output device 40 includes part of the frame 11, the vibration mechanism 12, and the transmission member 15. The transmission member 15 transmits the vibration of the vibration mechanism 12 to the frame 11 as the member to be vibrated. In other words, the transmission member 15 is an example of a relay plate that relays the vibration of the vibration mechanism 12 to the frame 11. The transmission member 15 near the frame 11 is held at the frame 11 by a rubber cushion 32. The rubber cushion 32 is, for example, a member (flexible member) made of an elastomer, such as rubber. The rubber cushion 32 is capable of improving accuracy in assembling the vibration mechanism 12 and the transmission member 15. For the transmission member 15, for example, a processed stainless steel plate of approximately 1.5 mm thickness can be used.

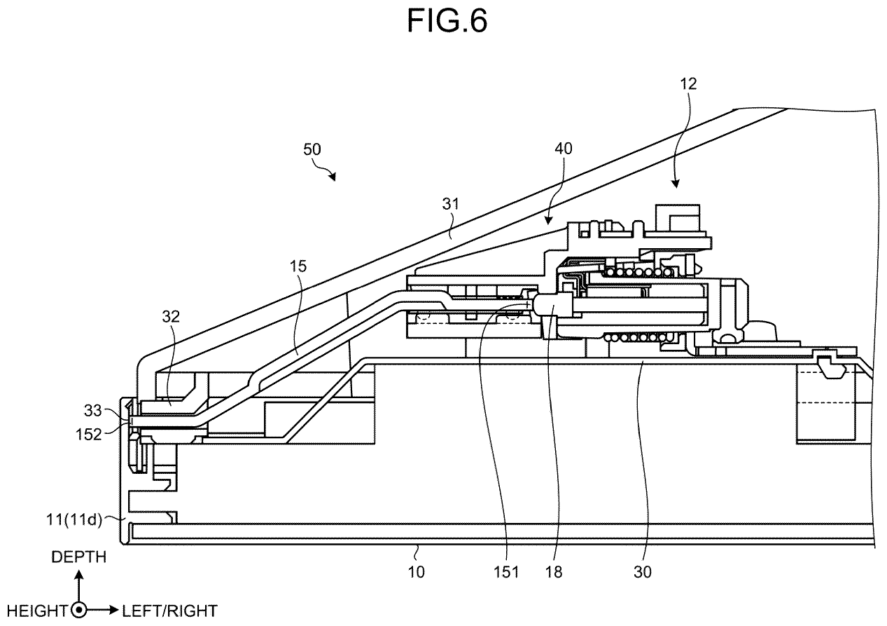

FIG. 6 is a cross-sectional view illustrating an exemplary configuration of a portion in the vicinity of the sound output device taken along line D-D illustrated in FIG. 1. As illustrated in FIG. 6, in the sound output device 40, for example, the frame 11 (11d) and the vibration mechanism 12 installed on the stationary member (back chassis) 30 are connected by the transmission member 15 bent so as to be stored in a rear cover 31. In other words, the transmission member 15 connecting the frame 11 and the vibration mechanism 12 is bent toward the display panel 10 from near the rear cover 31, relative to the vibration mechanism 12. In addition, the transmission member 15 includes a first end portion 151 that makes contact with the abutment member 18 of the vibration mechanism 12 and a second end portion 152 that makes contact with the frame 11 as the member to be vibrated. In the second end portion 152, the vicinity of the second end portion 152 is held at the frame 11 by the rubber cushion 32 so as to make contact with an inner surface 33 of the frame 11. The surface 33 is, for example, a vibration surface having a thickness of approximately 1 mm, and is thinner than the other portions of the frame 11.

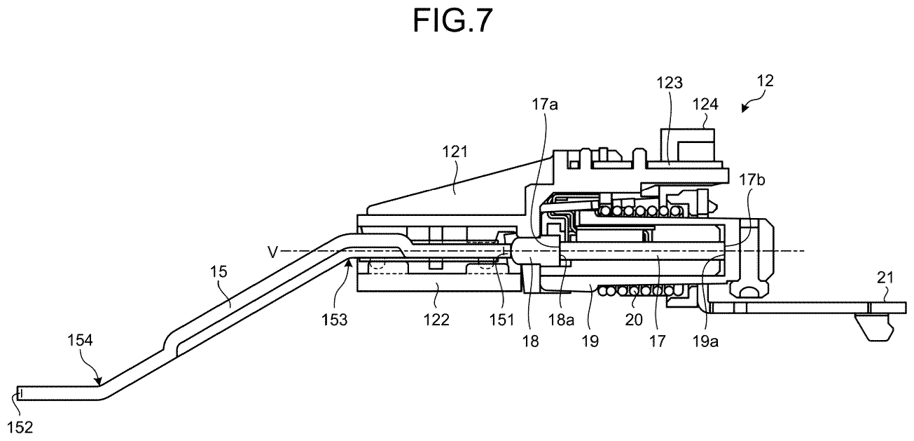

Next, the vibration mechanism 12 and the transmission member 15 will be described in detail with reference to FIGS. 7 to 11. FIG. 7 is a cross-sectional view of the vibration mechanism and the transmission member. As illustrated in FIG. 7, the vibration mechanism 12 includes the actuator 17, the abutment member 18, the support member 19, the coil spring 20, the fixing member 21, a cover member 121, a base member 122, a substrate 123, and a connector 124. As in FIG. 2A, the actuator 17 generates vibration along the vibration axis V. The actuator 17 has a first flat surface 17a near the abutment member 18, and the first flat surface 17a is managed to have a roughness equal to or less than a predetermined roughness to uniformly make contact with a flat surface 18a of the abutment member 18 near the actuator 17. In addition, the actuator 17 has a second flat surface 17b at an end portion on a side opposite from the abutment member 18, and the second flat surface 17b is managed to have a roughness equal to or less than the predetermined roughness to uniformly make contact with a flat surface 19a of the support member 19 that the second flat surface 17b faces. As in the second flat surface 17b, the flat surface 19a of the support member 19 is also managed to have a roughness equal to or less than the predetermined roughness. Note that the second flat surface 17b corresponds to the flat surface at the rear side end portion 25 of the actuator 17 illustrated in FIGS. 2B and 3.

The abutment member 18 is in contact with the first flat surface 17a of the actuator 17 that the flat surface 18a faces. The flat surface 18a is managed to have a roughness equal to or less than the predetermined roughness to uniformly make contact with the first flat surface 17a. The support member 19 supports the actuator 17. The coil spring 20 urges the support member 19 toward the transmission member 15. The fixing member 21 holds the support member 19 together with the cover member 121 and the base member 122. For the cover member 121 and the base member 122, for example, polycarbonate (PC) can be used.

The cover member 121 and the base member 122 holds therebetween the transmission member 15 from the first end portion 151 to the vicinity of a first bent portion 153 via a cushion material to fix the transmission member 15. In other words, the transmission member 15 is held so as to be slightly moved in the up/down direction by the cushion material. Furthermore, the cover member 121 supports the abutment member 18 and is connected to the fixing member 21. The cover member 121 and the fixing member 21 stores therebetween the support member 19 and the coil spring 20. The lead wires 24a and 24b of the piezoelectric elements 23a and 23b of the actuator 17 are connected to the substrate 123. In addition, the connector 124 is installed and the lead wires 24a and 24b and the wiring are connected, on the substrate 123. The wiring, which is not illustrated, for applying voltage to the piezoelectric elements 23a and 23b is connected to the connector 124.

The transmission member 15 is a plate-shaped member, and includes the first bent portion 153 positioned in the vicinity of the first end portion 151 and a second bent portion 154 positioned in the vicinity of the second end portion 152. The first bent portion 153 and the second bent portion 154 are bent in directions opposite to each other, and the transmission member 15 has a cross section having an elongated S shape as illustrated in FIG. 7. In addition, a section from the first end portion 151 to the first bent portion 153 and a section from the second end portion 152 to the second bent portion 154 are substantially parallel. In other words, in the transmission member 15, the second end portion 152 is positioned at a place different from that of the first end portion 151 positioned on the axis of the vibration axis V.

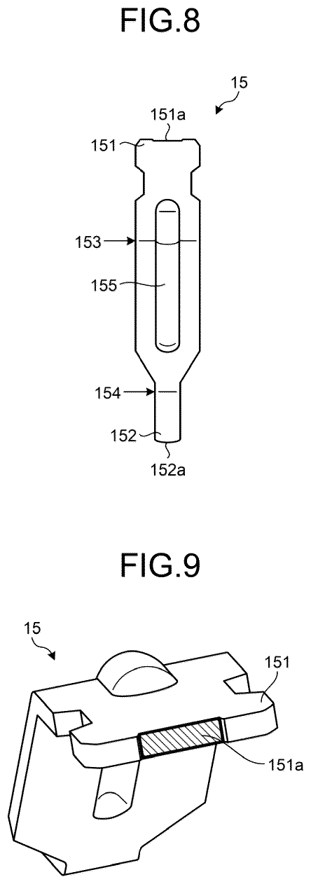

FIG. 8 is a top view of the transmission member according to an embodiment of the present disclosure. FIG. 9 is an enlarged view illustrating an example of the first end portion of the transmission member. As illustrated in FIGS. 8 and 9, the transmission member 15 is a plate-shaped member in which a width of the first end portion 151 is different from a width of the second end portion 152. For example, the width of the second end portion 152 is formed to be smaller than the width of the first end portion 151. The first end portion 151 has a portion making contact with the abutment member 18, and the portion is provided with a flat surface 151a. The flat surface 151a is managed to have a roughness equal to or less than the predetermined roughness. Furthermore, the second end portion 152 has a portion making contact with the frame 11, and the portion is provided with a columnar curved surface 152a processed into a curved surface in one direction. The curved surface 152a is, for example, a curved surface corresponding to the side surface of the column when viewed from above in FIG. 8. Note that the curved surface 152a may be a curved surface corresponding to the side surface of the column when the axis of the column is rotated by 90 degrees in a transverse direction of the transmission member 15. In other words, the curved surface 152a is such a curved surface that a part thereof makes line contact with the inner surface 33 of the frame 11.

The transmission member 15 has a center part that is provided with a reinforcing bead 155. The center portion of the transmission member 15 has a width substantially the same as the width of the first end portion 151. A side of the reinforcing bead 155 near the first end portion 151 extends beyond the first bent portion 153. Meanwhile, the second end portion 152 of the reinforcing bead 155 extends to a place in front of the second bent portion 154, where the width of the transmission member 15 starts to decrease. Note that the second end portion 152 has a smaller width than the first end portion 151 to reduce the mass, and therefore, a sound pressure level can be increased.

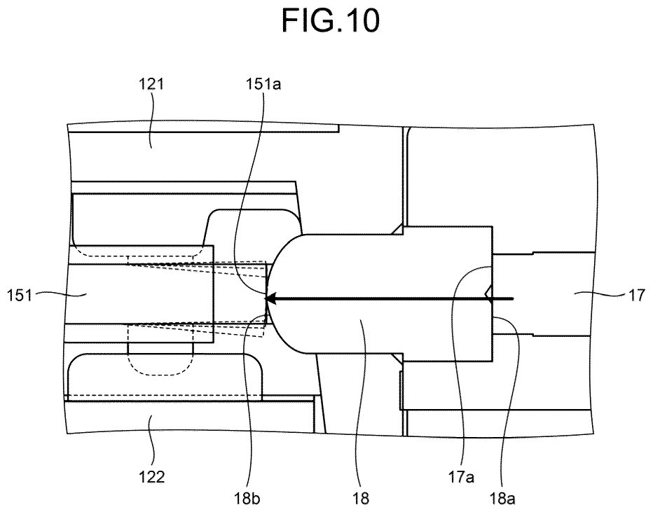

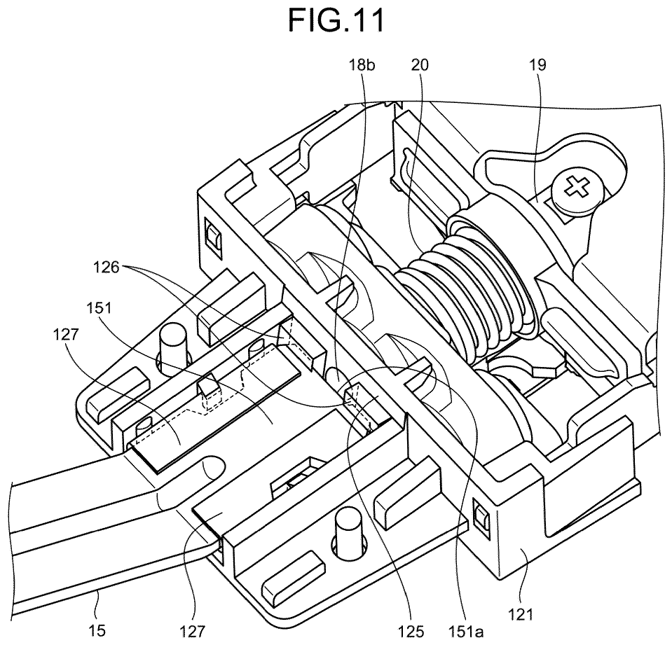

FIG. 10 is an enlarged cross-sectional view of contact portions of the abutment member of the vibration mechanism and the first end portion of the transmission member. As indicated by an arrow in FIG. 10, vibration generated by the actuator 17 is transmitted to the abutment member 18 via the first flat surface 17a and the flat surface 18a. The vibration is transmitted to the first end portion 151 of the transmission member 15 via a spherical portion 18b of the abutment member 18 and the flat surface 151a of the transmission member 15. At this time, the first end portion 151 is fixed by the cover member 121 and the base member 122, but the contact portions of the spherical portion 18b and the flat surface 151a may be different for each product due to, for example, variation in processing accuracy, assembly, temperature shrinkage, or the like of each of the portions. Meanwhile, in the present embodiment, of the contact portions of the abutment member 18 and the transmission member 15, one of the contact portions is formed as the spherical portion 18b that has a spherical surface and the other is formed as the flat surface 151a that has a flat surface, and therefore, the above-described variations can be accommodated, and the vibration can be stably transmitted from the abutment member 18 to the transmission member 15.

FIG. 11 is an enlarged view illustrating an example of a cushion member provided between the cover member of the vibration mechanism and the transmission member. As illustrated in FIG. 11, a cushion member 126 is provided between an end surface 125 of the cover member 121 and the first end portion 151 of the transmission member 15. The cushion member 126 uses, for example, an elastomer that can be squashed to some extent, such as urethane foam, is used. Before the vibration mechanism 12 and the transmission member 15 are assembled to the image display device 50, the flat surface 151a of the first end portion 151 and the spherical portion 18b of the abutment member 18 are separated by the cushion member 126. At this time, the first end portion 151 is incorporated in the cover member 121 and the base member 122 via a cushion material 127 provided to cover a side surface portion. Therefore, when the vibration mechanism 12 and the transmission member 15 are transported as a component, it is possible to suppress generation of metal powder due to vibration at the contact portions of the flat surface 151a and the spherical portion 18b. Note that for the cushion material 127, a material having low frictional resistance, for example, a nonwoven fabric or a fluororesin tape such as a polytetrafluoroethylene (PTFE) tape can be used.

When the vibration mechanism 12 and the transmission member 15 are assembled to the image display device 50, the support member 19 is urged toward the transmission member 15 by the coil spring 20. In other words, the actuator 17 and the abutment member 18 are also urged toward the transmission member 15. Furthermore, the transmission member 15 is also pressed against the frame 11, and therefore, a pressing force is generated in a direction of the abutment member 18. These forces squash the cushion member 126, and the spherical portion 18b of the urged abutment member 18 and the flat surface 151a of the transmission member 15 are brought into contact with each other with a predetermined force.

### 2. Modifications of Embodiment

Incidentally, in the embodiment described above, the transmission member 15 having the plate shape has been arranged in the vicinity of the frame 11 together with the vibration mechanism 12, but the transmission member 15 may have other shapes, and transmission members having the other shapes will be described as first and second modifications. Furthermore, the vibration mechanism 12 may be arranged at a portion closer to the center portion of the image display device 50, and image display devices arranged closer to the center portion will be described as third and fourth modifications. Note that, in the first to fourth modifications, the same reference numerals are assigned to the same configurations as those of the image display device 50 of the embodiment described above, and repetitive description of the configurations and operations will be omitted.

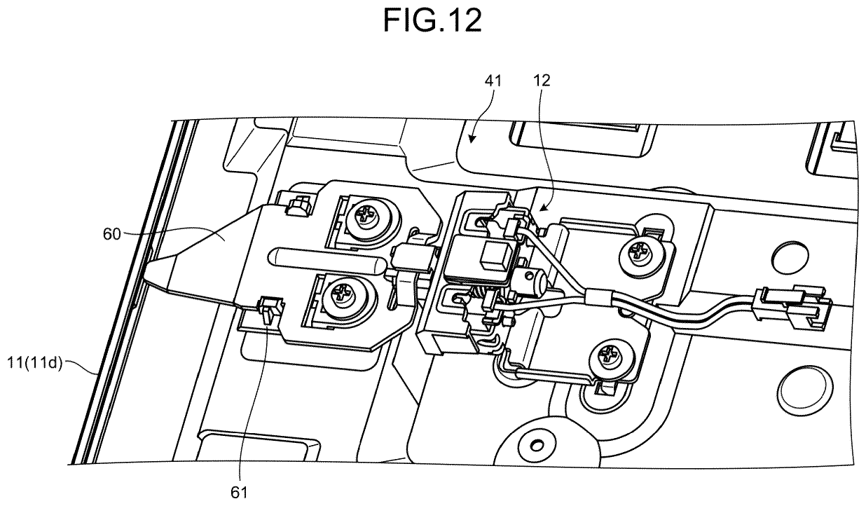

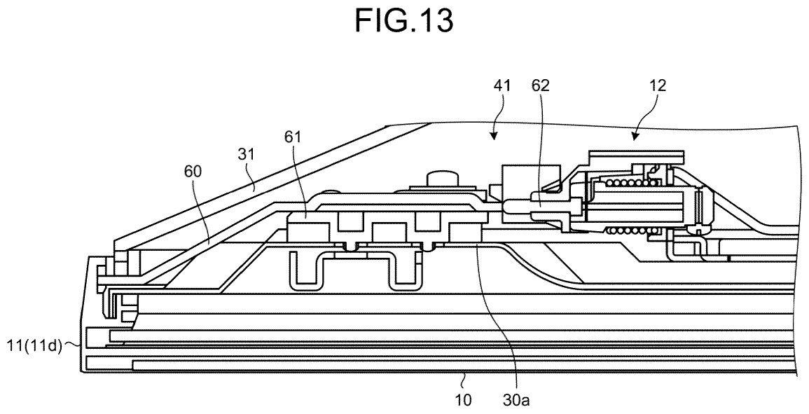

FIG. 12 is a perspective view illustrating an exemplary configuration of a sound output device according to the first modification. FIG. 13 is a cross-sectional view illustrating an exemplary configuration of a portion in the vicinity of the sound output device according to the first modification. As illustrated in FIGS. 12 and 13, a sound output device 41 of the first modification is different from the sound output device 40 of the embodiment in that a transmission member 60 is provided instead of the transmission member 15. The transmission member 60 is installed on a back chassis 30a via a support member 61. The transmission member 60 is formed of a metal plate whose width is larger near the vibration mechanism 12 than that of the transmission member 15 of the embodiment. For the transmission member 60, for example, a processed stainless steel plate of approximately 1.5 mm thickness can be used. An end portion of the transmission member 60 near the vibration mechanism 12 is in contact with an abutment member 62 of the vibration mechanism 12 at the center part in the width direction. In addition, in the transmission member 60, the metal plate has a tapered shape tapered to the frame 11 and has an end portion near the frame 11 that is in contact with the frame 11. The transmission member 60 transmits the vibration of the vibration mechanism 12 to the frame 11 as the member to be vibrated.

As illustrated in FIG. 13, in the sound output device 41, for example, the frame 11 (11d) and the vibration mechanism 12 installed on the back chassis 30a are connected by the transmission member 60 bent so as to be stored in the rear cover 31. In other words, the transmission member 60 connecting the frame 11 and the vibration mechanism 12 is bent toward the display panel 10 from near the rear cover 31, relative to the vibration mechanism 12.

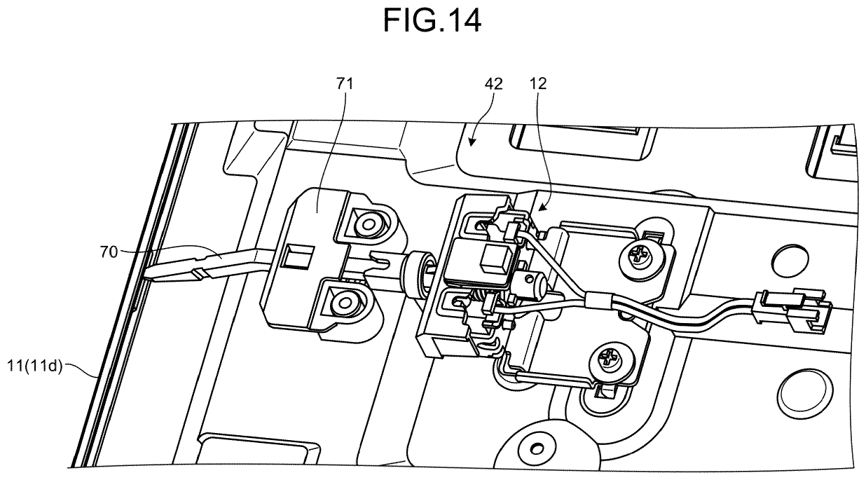

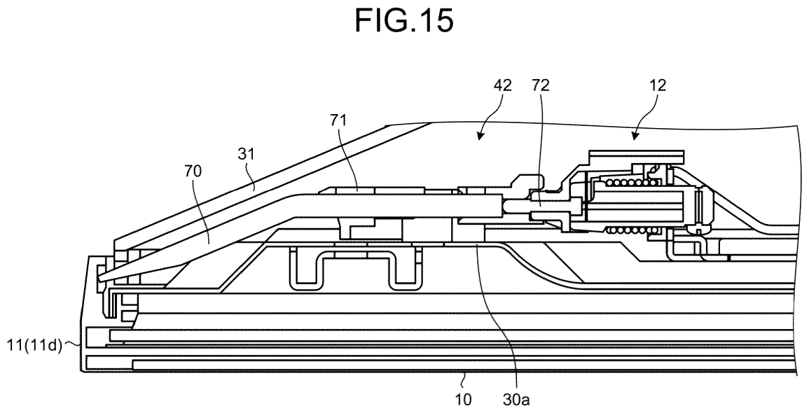

FIG. 14 is a perspective view illustrating an exemplary configuration of a sound output device according to the second modification. FIG. 15 is a cross-sectional view illustrating an exemplary configuration of a portion in the vicinity of the sound output device according to the second modification. As illustrated in FIGS. 14 and 15, a sound output device 42 of the second modification is different from the sound output device 40 of the embodiment in that a transmission member 70 is provided instead of the transmission member 15. The transmission member 70 is installed on the back chassis 30a via a support member 71. The transmission member 70 is formed of a square rod having a predetermined size. For the transmission member 70, for example, a processed stainless steel rod of approximately 4 mm square can be used. An end portion of the transmission member 70 near the vibration mechanism 12 is in contact with an abutment member 72 of the vibration mechanism 12 at the center part of the end portion. Furthermore, in the cross-section of the transmission member 70 as illustrated in FIG. 15, the transmission member 70 has a wedge shape whose thickness becomes thin in the vicinity of the frame 11 and has an end portion near the frame 11 that is in contact with the frame 11. The transmission member 70 transmits the vibration of the vibration mechanism 12 to the frame 11 as the member to be vibrated.

As illustrated in FIG. 15, in the sound output device 42, for example, the frame 11 (11d) and the vibration mechanism 12 installed on the back chassis 30a are connected by the transmission member 70 bent so as to be stored in the rear cover 31. In other words, the transmission member 70 connecting the frame 11 and the vibration mechanism 12 is bent toward the display panel 10 from near the rear cover 31, relative to the vibration mechanism 12.

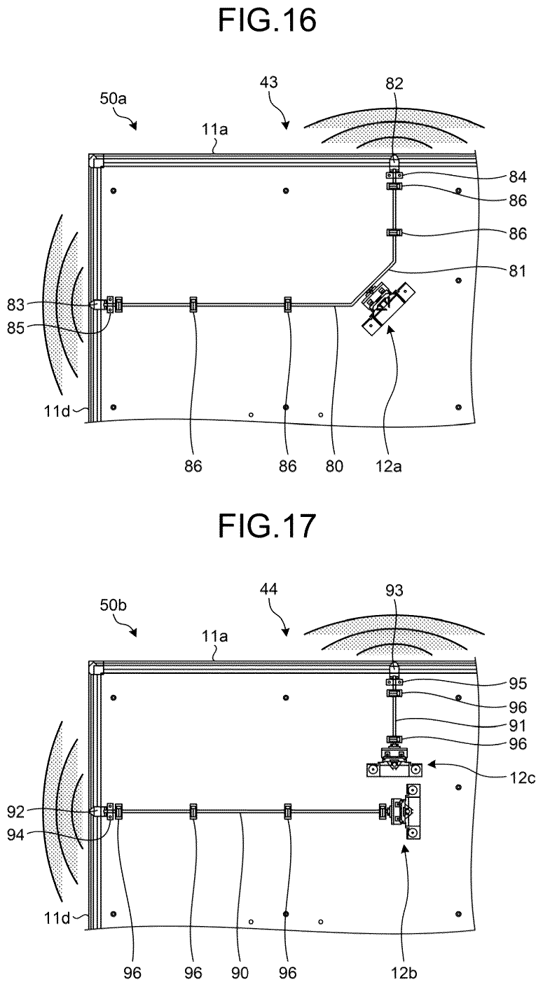

FIG. 16 is a diagram illustrating an exemplary configuration of a sound output device according to the third modification. As illustrated in FIG. 16, in an image display device 50a of the third modification, the vibration mechanism 12a is arranged, as a sound output device 43, at the center part of the image display device 50a positioned away from the frames 11a and 11d. Note that, FIG. 16 illustrates an upper left part of the image display device 50a as viewed from the back side, and the upper left part and an upper right part which is omitted are symmetric with respect to the center line of the image display device 50a.

A transmission member 80 is configured as one member that connects an end portion 82 making contact with the frame 11a and an end portion 83 making contact with the frame 11d. Note that the end portions 82 and 83 may be provided with transmission members each similar to the transmission members 15, 60, or 70 described above so as to be connected to the transmission member 80. In the vicinity of the end portion 82, a support member 84 is provided that supports the end portion 82. In the vicinity of the end portion 83, a support member 85 is provided that supports the end portion 83. In addition, the transmission member 80 has intermediate parts provided with a plurality of support members 86 to support the transmission member 80. The transmission member 80 has a side surface 81 that is in contact with the vibration mechanism 12a. The vibration of the vibration mechanism 12a is transmitted to both the end portion 82 and the end portion 83 via the side surface 81 and the transmission member 80, and sound is output from the frame 11a and the frame 11d. In this configuration, the sound output device 43 is configured to output sound from two places of the frame 11 by one vibration mechanism 12a. In other words, the image display device 50a is configured to output sound from one left side place and one right side place and two upper side places of the frame 11. This configuration makes it possible to increase the effect of surround sound.

FIG. 17 is a diagram illustrating an exemplary configuration of a sound output device according to the fourth modification. As illustrated in FIG. 17, in an image display device 50b of the fourth modification, the vibration mechanisms 12b and 12c are arranged, as a sound output device 44, at the center part of the image display device 50b, away from the frames 11d and 11a. Note that FIG. 17 illustrates an upper left portion of the image display device 50b as viewed from the back side, and the upper left portion and an upper right portion which is omitted are symmetric with respect to the center line of the image display device 50b.

A transmission member 90 is connected to the vibration mechanism 12b. The transmission member 90 has an end portion 92 that is in contact with the frame 11d. In the vicinity of the end portion 92, a support member 94 is provided that supports the end portion 92. A transmission member 91 is connected to the vibration mechanism 12c. The transmission member 91 has an end portion 93 that is in contact with the frame 11a. In the vicinity of the end portion 93, a support member 95 is provided that supports the end portion 93. Note that the end portions 92 and 93 may be provided with transmission members each similar to the transmission members 15, 60, or 70 described above so as to be connected to the transmission members 90 and 91. In addition, the transmission members 90 and 91 have intermediate parts provided with a plurality of support members 96 to support the transmission members 90 and 91. The transmission members 90 and 91 have end portions on sides opposite from the end portions 92 and 93, in contact with the vibration mechanisms 12b and 12c, respectively. The vibrations of the vibration mechanisms 12b and 12c are transmitted to the end portions 92 and 93 via the transmission members 90 and 91, respectively, and sounds are output from the frame 11d and the frame 11a, respectively. In this configuration, the vibration mechanisms 12b and 12c are configured to be individually driven, and therefore, different sounds can be output between the frame 11d and the frame 11a. In other words, the image display device 50b includes, as the sound output device 44, two vibration mechanisms 12b and two vibration mechanisms 12c, and therefore, different sounds can be output from one place on each of the left and right sides and two locations on the upper side of the frame 11.

The present technology is not limited to the embodiments and modifications described above, and various other embodiments can be achieved.

In the embodiments described above, the television device is exemplified as the image display device 50, but the present technology is not limited thereto. For example, the present technology may be applied to a picture frame or the like holding a picture or the like to output sound from a frame of the picture frame.

Furthermore, the configurations of the respective members, the vibration mechanism 12, and the like included in the image display device 50 and the like are merely an embodiment, and can be appropriately changed without departing from the scope of the present technology. In other words, any other configuration and the like for carrying out the present technology may be adopted.

Furthermore, the embodiments and modifications described above can be appropriately combined within a range consistent with the contents of the configurations.

### 3. Effects

The sound output device 40 includes the member to be vibrated (frame 11) that outputs sound to a space, the vibration mechanism 12 that vibrates the member to be vibrated, and the transmission member 15 that transmits the vibration of the vibration mechanism 12 to the member to be vibrated. The vibration mechanism 12 includes the actuator 17 that generates vibration along the predetermined vibration axis, and the abutment member 18 that is provided near the transmission member 15 in the axial direction of the vibration axis of the actuator 17 to transmit the vibration generated by the actuator 17 to the transmission member 15. The transmission member 15 includes the first end portion 151 that makes contact with the abutment member 18 and the second end portion 152 that makes contact with the member to be vibrated. Therefore, the vibration of the actuator 17 of the vibration mechanism 12 is configured to be stably transmitted to the frame 11 as the member to be vibrated, while reducing the thickness of the image display device 50.

The vibration mechanism 12 includes the support member 19 that supports the actuator 17. In the actuator 17, the second flat surface 17b on the side opposite from the first flat surface 17a making contact with the abutment member 18 is in contact with the support member 19, and the roughness of each of the first flat surface 17a and the second flat surface 17b is equal to or less than the predetermined roughness. Therefore, variations in the sound pressure level of output sound is allowed to be suppressed.

In the first end portion 151, the roughness of the flat surface making contact with the abutment member 18 is equal to or less than the predetermined roughness, and in the abutment member 18, the end portion (spherical portion 18b) making contact with the first end portion 151 is processed into a spherical shape. Therefore, the vibration is allowed to be stably transmitted from the abutment member 18 to the transmission member 15.

The second end portion 152 is processed into a curved surface in one direction, and part of the curved surface is in contact with the member to be vibrated. Therefore, the vibration is allowed to be stably transmitted from the transmission member 15 to the frame 11.

The transmission member 15 has a plate shape in which the width of the first end portion 151 is different from the width of the second end portion 152. Therefore, the vibration is allowed to be stably transmitted from the transmission member 15 to the frame 11.

In the transmission member 15, the second end portion 152 is positioned at a place different from that on the axis of the vibration axis. Therefore, the vibration of the vibration mechanism 12 is allowed to be stably transmitted to the frame 11, even when there is a limitation on a space in the vicinity of the frame 11.

The transmission member 15 is bent in the vicinities of the first end portion 151 and the second end portion 152, in directions opposite to each other. Therefore, the vibration of the vibration mechanism 12 is allowed to be transmitted to a place different from that on the axis of the vibration axis.

The vibration mechanism 12 includes the urging member 20 that is provided around the support member 19 when viewed along the vibration axis, at least part of which is arranged closer to the transmission member 15 relative to the second flat surface 17b of the actuator 17 in the axial direction of the vibration axis, and that urges the support member 19 toward the transmission member 15. Therefore, the vibration of the actuator 17 is allowed to be stably transmitted to the transmission member 15 and the frame 11.

The cushion member 126 is provided between the first end portion 151 of the transmission member 15 and the end portion (the end surface 125) of the cover member 121 near the transmission member 15, the support member 19 being stored in the cover member 121. The transmission member 15 and the abutment member 18 are separated from each other by the cushion member 126 when the abutment member 18 is not urged by the urging member 20, and are brought into contact with each other by deformation of the cushion member 126 when the abutment member 18 is urged by the urging member 20. Therefore, when the vibration mechanism 12 and the transmission member 15 are transported as a component, generation of metal powder due to vibration can be suppressed.

The transmission member 15 on the side of the second end portion 152 is held at the member to be vibrated by the flexible member (rubber cushion 32). Therefore, accuracy in assembling the vibration mechanism 12 and the transmission member 15 can be improved.

The abutment member 18 of the vibration mechanism 12 and the transmission member 15 are made of different metals. Therefore, both of sound transmission characteristics and processability of the members can be achieved.

The member to be vibrated is a frame that supports the display panel 10 having a screen display function. Therefore, the user watching the display panel 10 can hear voice.

The actuator 17 includes a piezoelectric element or a dielectric elastomer. Therefore, vibration according to a voice signal is allowed to be generated.

The sound output device 43 includes a plurality of members to be vibrated (frame 11a and 11d) that outputs sound to a space, the vibration mechanism 12a that vibrates the plurality of members to be vibrated, and the transmission member 80 that transmits vibration of the vibration mechanism 12a to the plurality of members to be vibrated. The vibration mechanism 12a includes the actuator 17 that generates vibration along the predetermined vibration axis, and the abutment member 18 that is provided near the transmission member 80 in the axial direction of the vibration axis of the actuator 17 to transmit the vibration generated by the actuator 17 to the transmission member 80. The transmission member 80 includes the side surface 81 that makes contact with the abutment member 18 and a plurality of the end portions 82 and 83 that makes contact with the plurality of members to be vibrated, respectively. Therefore, the vibration of the actuator 17 of the vibration mechanism 12 is allowed to be stably transmitted to the frame 11 as the member to be vibrated, while reducing the thickness of the display panel 10. In addition, sound is allowed to be output from two places of the frame 11 with one vibration mechanism 12a.

Note that the effects described herein are merely examples and are not limited to the description, and other effects may be provided.

Note that the present technology can also have the following configurations.

(1)

A sound output device comprising:
a member to be vibrated that outputs sound to a space;
a vibration mechanism that vibrates the member to be vibrated; and
a transmission member that transmits vibration of the vibration mechanism to the member to be vibrated, wherein
the vibration mechanism includes:
an actuator that generates the vibration along a predetermined vibration axis; and
an abutment member that is provided near the transmission member in an axial direction of the vibration axis of the actuator to transmit the vibration generated by the actuator to the transmission member, and
the transmission member includes:
a first end portion that makes contact with the abutment member; and
a second end portion that makes contact with the member to be vibrated.

(2)

The sound output device according to (1), wherein the vibration mechanism includes
a support member that supports the actuator, and
the actuator has a second flat surface on a side opposite from a first flat surface making contact with the abutment member, the second flat surface makes contact with the support member, and the first flat surface and the second flat surface each have a roughness equal to or less than a predetermined roughness.

(3)

The sound output device according to (1) or (2), wherein
the first end portion has a flat surface making contact with the abutment member, and the flat surface has a roughness equal to or less than a predetermined roughness, and
the abutment member has an end portion making contact with the first end portion, and the end portion is processed into a spherical shape.

(4)

The sound output device according to any one of (1) to (3), wherein
the second end portion is processed into a curved surface in one direction, and part of the curved surface is in contact with the member to be vibrated.

(5)

The sound output device according to any one of (1) to (4), wherein
the transmission member has a plate shape in which a width of the first end portion is different from a width of the second end portion.

(6)

The sound output device according to any one of (1) to (5), wherein
in the transmission member, the second end portion is positioned at a place different from that on an axis of the vibration axis.

(7)

The sound output device according to any one of (1) to (6), wherein
the transmission member is bent near the first end portion and the second end portion, in directions opposite to each other.

(8)

The sound output device according to (2), wherein
the vibration mechanism includes
an urging member that is provided around the support member when viewed along the vibration axis, at least part of which is arranged closer to the transmission member relative to the second flat surface of the actuator in the axial direction of the vibration axis, and that urges the support member toward the transmission member.

(9)

The sound output device according to (8), wherein
a cushion member is provided between the first end portion of the transmission member and an end portion of a cover member near the transmission member, the support member being stored in the cover member, and
the transmission member and the abutment member are separated from each other by the cushion member while the abutment member is not urged by the urging member, and are brought into contact with each other by deformation of the cushion member when the abutment member is urged by the urging member.

(10)

The sound output device according to any one of (1) to (9), wherein
the transmission member on a side of the second end portion is held at the member to be vibrated by a flexible member.

(11)

The sound output device according to any one of (1) to (10), wherein
the abutment member of the vibration mechanism and the transmission member are made of different metals.

(12)

The sound output device according to any one of (1) to (11), wherein
the member to be vibrated is a frame that supports a display panel having a screen display function.

(13)

The sound output device according to any one of (1) to (11), wherein
the actuator includes a piezoelectric element or a dielectric elastomer.

(14)

A sound output device comprising:
a plurality of members to be vibrated that outputs sound to a space;
a vibration mechanism that vibrates the plurality of members to be vibrated; and
a transmission member that transmits vibration of the vibration mechanism to the plurality of members to be vibrated, wherein
the vibration mechanism includes:
an actuator that generates the vibration along a predetermined vibration axis; and
an abutment member that is provided near the transmission member in an axial direction of the vibration axis of the actuator to transmit the vibration generated by the actuator to the transmission member, and
the transmission member includes:
a side surface that makes contact with the abutment member; and
a plurality of end portions that makes contact with the plurality of members to be vibrated.

### REFERENCE SIGNS LIST

10 DISPLAY PANEL
11 FRAME
12, 12a VIBRATION MECHANISM
15, 80 TRANSMISSION MEMBER
17 ACTUATOR
18 ABUTMENT MEMBER
19 SUPPORT MEMBER
20 URGING MEMBER (COIL SPRING)
40 to 44 SOUND OUTPUT DEVICE
50, 50a, 50b IMAGE DISPLAY DEVICE
151 FIRST END PORTION
152 SECOND END PORTION

1. A sound output device comprising:
a member to be vibrated that outputs sound to a space;
a vibration mechanism that vibrates the member to be vibrated; and
a transmission member that transmits vibration of the vibration mechanism to the member to be vibrated, wherein
the vibration mechanism includes:
an actuator that generates the vibration along a predetermined vibration axis; and
an abutment member that is provided near the transmission member in an axial direction of the vibration axis of the actuator to transmit the vibration generated by the actuator to the transmission member, and
the transmission member includes:
a first end portion that makes contact with the abutment member; and
a second end portion that makes contact with the member to be vibrated.

2. The sound output device according to claim 1, wherein
the vibration mechanism includes
a support member that supports the actuator, and
the actuator has a second flat surface on a side opposite from a first flat surface making contact with the abutment member, the second flat surface makes contact with the support member, and the first flat surface and the second flat surface each have a roughness equal to or less than a predetermined roughness.

3. The sound output device according to claim 1, wherein
the first end portion has a flat surface making contact with the abutment member, and the flat surface has a roughness equal to or less than a predetermined roughness, and
the abutment member has an end portion making contact with the first end portion, and the end portion is processed into a spherical shape.

4. The sound output device according to claim 1, wherein
the second end portion is processed into a curved surface in one direction, and part of the curved surface is in contact with the member to be vibrated.

5. The sound output device according to claim 1, wherein
the transmission member has a plate shape in which a width of the first end portion is different from a width of the second end portion.

6. The sound output device according to claim 1, wherein
in the transmission member, the second end portion is positioned at a place different from that on an axis of the vibration axis.

7. The sound output device according to claim 6, wherein
the transmission member is bent near the first end portion and the second end portion, in directions opposite to each other.

8. The sound output device according to claim 2, wherein
the vibration mechanism includes
an urging member that is provided around the support member when viewed along the vibration axis, at least part of which is arranged closer to the transmission member relative to the second flat surface of the actuator in the axial direction of the vibration axis, and that urges the support member toward the transmission member.

9. The sound output device according to claim 8, wherein
a cushion member is provided between the first end portion of the transmission member and an end portion of a cover member near the transmission member, the support member being stored in the cover member, and
the transmission member and the abutment member are separated from each other by the cushion member while the abutment member is not urged by the urging member, and are brought into contact with each other by deformation of the cushion member when the abutment member is urged by the urging member.

10. The sound output device according to claim 1, wherein
the transmission member on a side of the second end portion is held at the member to be vibrated by a flexible member.

11. The sound output device according to claim 1, wherein
the abutment member of the vibration mechanism and the transmission member are made of different metals.

12. The sound output device according to claim 1, wherein
the member to be vibrated is a frame that supports a display panel having a screen display function.

13. The sound output device according to claim 1, wherein
the actuator includes a piezoelectric element or a dielectric elastomer.

14. A sound output device comprising:
a plurality of members to be vibrated that outputs sound to a space;
a vibration mechanism that vibrates the plurality of members to be vibrated; and
a transmission member that transmits vibration of the vibration mechanism to the plurality of members to be vibrated, wherein
the vibration mechanism includes:
an actuator that generates the vibration along a predetermined vibration axis; and
an abutment member that is provided near the transmission member in an axial direction of the vibration axis of the actuator to transmit the vibration generated by the actuator to the transmission member, and
the transmission member includes:
a side surface that makes contact with the abutment member; and
a plurality of end portions that makes contact with the plurality of members to be vibrated.
